(19) United States
(12) Patent Application Publication
(10) Pub. No.: US 2026/0301142 A1
(43) Pub. Date: Oct. 1, 2026

(54) ANALYSIS SYSTEM AND ANALYSIS METHOD

(71) Applicant: TOYOTA JIDOSHA KABUSHIKI KAISHA, Toyota-shi (JP)

(72) Inventors: Kazuho SAEKI, Kawasaki-shi (JP); Takuto INOUE, Nisshin-shi (JP)

(73) Assignee: TOYOTA JIDOSHA KABUSHIKI KAISHA, Toyota-shi (JP)

(21) Appl. No.: 19/545,250

(22) Filed: Feb. 20, 2026

(30) Foreign Application Priority Data
Apr. 1, 2025 (JP) 2025-060298

(51) Int. Cl. G06T 7/00; G06T 5/50

(52) U.S. Cl. CPC G06T 7/0002; G06T 5/50

(57) ABSTRACT

An analysis system according to the present disclosure includes an image acquisition unit that acquires an image to be analyzed, an image processing unit that generates a masking image in which an object other than the object is masked in the image, and a feature amount acquisition unit that acquires a feature amount of the masking image.

### CROSS-REFERENCE TO RELATED APPLICATION

This application claims priority to Japanese Patent Application No. 2025-060298 filed on Apr. 1, 2025. The disclosure of the above-identified application, including the specification, drawings, and claims, is incorporated by reference herein in its entirety.

### BACKGROUND

### 1. Technical Field

The present disclosure relates to an analysis system and an analysis method.

### 2. Description of Related Art

Japanese Unexamined Patent Application Publication No. 2024-108021 (JP 2024-108021 A) discloses an information processing device that generates power spectrum data from an image and performs principal component analysis on the power spectrum data. The information processing device of JP 2024-108021 A performs the principal component analysis on the power spectrum data to generate a principal component vector representing a basis vector of the power spectrum data and a principal component score representing a contained amount of the principal component vector.

### SUMMARY

The information processing device described in JP 2024-108021 A performs the principal component analysis after converting an image into a power spectrum. That is, the information processing device described in JP 2024-108021 A extracts a feature amount from image data.

When a feature amount is extracted from a plurality of pieces of image data, for example, an object or a background different from a target object in the image may be reflected in the feature amount. As a result, the accuracy of extraction of the feature amount may decrease. JP 2024-108021 A does not disclose a technology that can solve such a problem.

The present disclosure has been made to solve such a problem, and an object thereof is to provide an analysis system and an analysis method that can improve the accuracy of extraction of a feature amount.

An analysis system according to the present disclosure includes:
an image acquisition unit configured to acquire an image to be analyzed;
an image processing unit configured to generate a masking image in which an object in the image other than a target object is masked; and
a feature amount acquisition unit configured to acquire a feature amount in the masking image.

The feature amount acquisition unit may be configured to perform two-dimensional principal component analysis on the masking image to acquire a principal component score and a principal component vector as the feature amount.

The analysis system may further include: a change reception unit configured to acquire the principal component score subjected to a change; an image generation unit configured to generate a first reconstructed image based on the principal component vector and the principal component score before the change, and generate a second reconstructed image based on the principal component vector and the principal component score after the change; and a display control unit configured to display the first reconstructed image and the second reconstructed image for a user.

The image generation unit may be configured to calculate a difference between the first reconstructed image and the second reconstructed image, and generate a difference image based on the difference.

An analysis method according to the present disclosure includes: acquiring an image to be analyzed; generating a masking image in which an object in the image other than a target object is masked; and acquiring a feature amount in the masking image.

According to the present disclosure, it is possible to provide the analysis system and the analysis method that can improve the accuracy of extraction of the feature amount.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a configuration of an analysis system according to a first embodiment;

FIG. 2 is a block diagram illustrating a hard configuration of a server according to Embodiment 1;

FIG. 3 is a block diagram illustrating a function of the server according to the first embodiment;

FIG. 4 is a schematic diagram illustrating an exemplary configuration of a display screen displayed on a user terminal by the display control unit according to Embodiment 1; and

FIG. 5 is a flowchart illustrating an analysis method according to Embodiment 1.

### DETAILED DESCRIPTION OF EMBODIMENTS

Hereinafter, specific embodiments of the present disclosure will be described in detail with reference to the drawings. However, the present disclosure is not limited to the following embodiments. Further, for clarity of explanation, the following description and the drawings are simplified as appropriate.

### Embodiment 1

### Configuration of Analysis System

The analysis system according to the first embodiment is a system for analyzing an image and displaying an analysis result to a user. More specifically, the analysis system 1 is provided as a part of a data cloud type service used in material development and research and development, and is used as a system for promoting research and development using so-called Materials Informatics (MI) and data science. In this case, the analysis system 1 stores, for example, various images of the newly developed material. Then, the analysis system 1 appropriately uses the stored image as an analysis target image based on an instruction from the user.

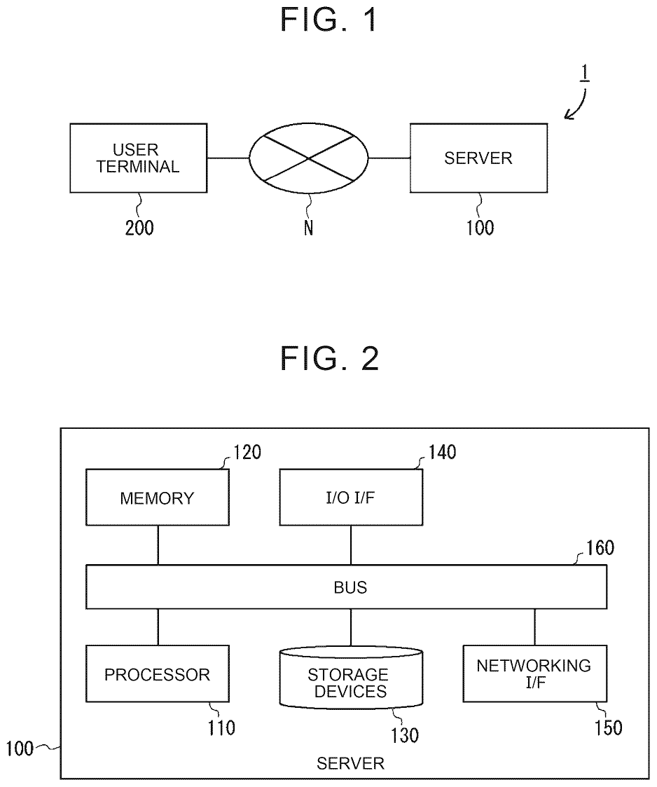

FIG. 1 is a block diagram illustrating a configuration of an analysis system according to a first embodiment. As illustrated in FIG. 1, the analysis system 1 according to the first embodiment includes a server 100 and a user terminal 200. The server 100 and the user terminal 200 are connected to each other in a state of being able to transmit information via the network N. The network N includes a radio line via a base station or the like, such as the Internet, Local Area Network (LAN) and Wide Area Network (WAN). The network N may be wired or wireless as long as it is connected in a state in which information can be transmitted.

In the analysis system 1, the user terminal 200 transmits an image to the server 100. The server 100 analyzes the received image. After the analysis, the server 100 transmits the analysis result to the user terminal 200. Then, the user terminal 200 displays the received analysis result to present the analysis result to the user. Note that the image is not particularly limited, and any data may be used as long as the image can be an object of principal component analysis.

The image analyzed by the analysis system 1 (hereinafter referred to as “original image”) includes, for example, an optical microscope, a Scanning Electron Microscope (SEM), a Transmission Electron Microscope (TEM), a Computed Tomography (CT), and the like. The material is, for example, a metal material, a resin material, or a coating material used in a vehicle. For example, the surface texture of the metal material varies depending on the type of the metal to be combined and the composition thereof. It is not easy for the user to grasp the difference in the surface tissue from the image. Therefore, the analysis system 1 extracts a feature amount from a plurality of images, and visualizes which region in the image is changed by the change in the feature amount. As a result, the analysis system 1 can make it easy for the user to grasp an important feature amount that affects the performance of the material. The performance of the material is, for example, battery performance, magnet performance, rigidity, thermoplasticity, tensile performance or mechanical durability.

The user terminal 200 is a terminal operated by a user and is a computer device having a display device. The user terminal 200 transmits the original image to the server 100 via the network N. Then, the user terminal 200 receives the analysis result of the original image from the server 100 via the network N.

The server 100 receives the original image from the user terminal 200 and analyzes the received original image. Then, the server 100 transmits the analysis result of the original image to the user terminal 200 via the network N.

FIG. 2 is a block diagram illustrating a hardware configuration of a server according to Embodiment 1. As illustrated in FIG. 2, the server 100 includes a processor 110, a memory 120, a storage device 130, an input/output interface 140, a network interface 150, and an internal bus 160.

The internal bus 160 is a data transmission path through which the processor 110, the memory 120, the storage device 130, the input/output interface 140, and the network interface 150 transmit and receive data to and from each other. However, the method of connecting the processors 110 and the like to each other is not limited to the bus connection.

The memory 120 is a main storage device realized by using Random Access Memory (RAM).

The storage device 130 is an auxiliary storage device realized by using a hard disk, a Solid State Drive (SSD), a memory card, a Read Only Memory (ROM), or the like. The storage device 130 stores a program for realizing a desired function.

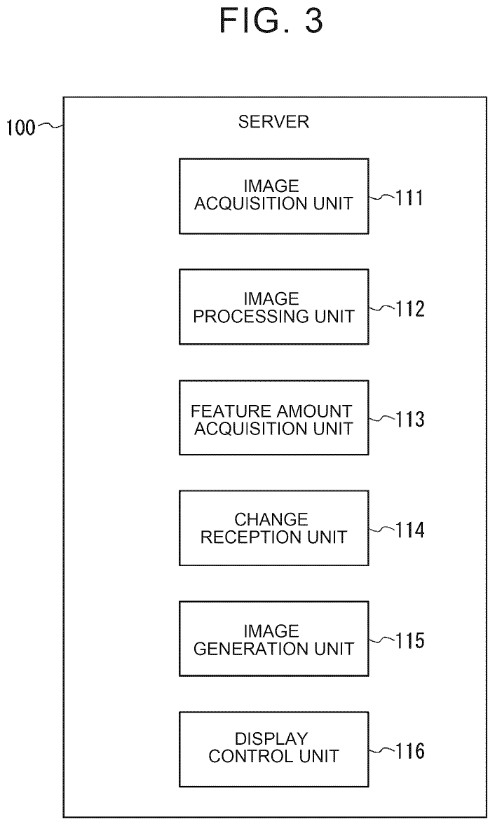

The processor 110 is a variety of processors, such as Central Processing Unit (CPU), Graphics Processing Unit (GPU), or field-programmable gate array (FPGA). The processor 110 reads a program stored in the storage device 130 into the memory 120 and executes the program, thereby executing a function as each functional block illustrated in FIG. 3 to be described later.

The input/output interface 140 is an interface for connecting the server 100 and the input/output device. For example, an input device such as a keyboard or an output device such as a display device may be connected to the input/output interface 140.

The network interface 150 is an interface for connecting the server 100 to a network.

It should be noted that the program includes instructions (or software code) for causing a computer to perform one or more of the functions described in the embodiments when the program is read into the computer. The program may be stored in a non-transitory computer-readable medium or a tangible storage medium. By way of example, and not limitation, computer-readable media or tangible storage media include RAM, ROM, flash memory, SSD or other memory techniques, CD-ROM, digital versatile disc (DVD), Blu-ray disk or other optical disk storage, magnetic cassettes, magnetic tape, magnetic disk storage, or other magnetic storage devices. The program may be transmitted on a transitory computer readable medium or a communication medium. By way of example, and not limitation, transitory computer-readable media or communication media include electrical, optical, acoustic, or other forms of propagated signals.

FIG. 3 is a block diagram illustrating functions of the server according to the first embodiment. As illustrated in FIG. 3, the server 100 includes an image acquisition unit 111, an image processing unit 112, a feature amount acquisition unit 113, a change reception unit 114, an image generation unit 115, and a display control unit 116 as functional blocks.

The image acquisition unit 111 acquires one or more original images. More specifically, the image acquisition unit 111 acquires one or a plurality of original images from the user terminal 200 via the network N. Then, the image acquisition unit 111 outputs the acquired one or more original images to the image processing unit 112.

Note that the image acquisition unit 111 does not need to acquire a plurality of original images by one reception. For example, the image acquisition unit 111 may acquire the original image in a plurality of times. In this case, the image acquisition unit 111 may store the acquired original image in the storage device 130 every time the original image is acquired. When analyzing the original image, the image acquisition unit 111 may read the original image to be analyzed from the storage device 130 and output the original image to the image processing unit 112.

The image acquisition unit 111 does not need to read all the original images stored in the storage device 130, and may read only the original image designated by the user and output the original image to the image processing unit 112. That is, the image acquisition unit 111 may create a database in which the original image is stored. The image acquisition unit 111 according to the first embodiment may be configured such that the user can appropriately select the source image to be analyzed from the created database.

The image processing unit 112 acquires the original image from the image acquisition unit 111. The image processing unit 112 generates a masking image in which an object other than the object is masked in the original image. The image processing unit 112 outputs the masking image to the feature amount acquisition unit 113.

The object according to the first embodiment indicates an object, a region, or the like designated as an analysis target. The object may be specified by the user or automatically detected based on a preset condition.

The image processing unit 112 performs masking processing using, for example, background removal, object extraction, or the like.

The image processing unit 112 can apply, for example, a background removal technique using a deep learning technique. The image processing unit 112 detects a foreground object from the original image using the learned model. Then, the image processing unit 112 removes the background portion from the original image and generates a masking image.

The image processing unit 112 can apply an object-extracting technique using, for example, Vision Transformer (ViT). The image processing unit 112 extracts an object in the original image based on a point, a bounding box, or the like designated by the user. Then, the image processing unit 112 generates a masking image including only the extracted object.

Note that the above-described masking processing is an example, and the masking processing executed by the image processing unit 112 is not limited to these. Other masking techniques and algorithms can be applied to the image processing unit 112. The image processing unit 112 can also apply an image processing technique other than the masking technique.

The feature amount acquisition unit 113 acquires a masking image from the image processing unit 112. The feature amount acquisition unit 113 acquires the feature amount of the masking image. The feature amount acquisition unit 113 outputs the acquired feature amount to the image generation unit 115 and the display control unit 116.

The feature amount acquisition unit 113 can accurately extract the feature amount of the object by acquiring the feature amount of the masking image in which the object other than the object is masked in the original image.

The feature amount acquisition unit 113 may acquire the principal component scores as the feature quantities by executing, for example, Principle Component Analysis (PCA) on the masked images. Principal component scores and principal component vectors obtained by principal component analysis are particularly difficult for a user to intuitively understand among results obtained by analysis using feature amounts. Therefore, the analysis system 1 according to the present disclosure has a special effect when the principal component score is used as the feature amount.

The feature amount acquisition unit 113 may acquire the principal component scores as the feature quantities by executing, for example, 2D Principle Component Analysis (2D-PCA) on the masked images. The two-dimensional principal component analysis directly processes the image as a two-dimensional matrix. Therefore, the spatial arrangement of each pixel can be maintained as it is. As a result, the feature amount acquisition unit 113 can accurately capture position-specific information, for example, a luminance difference, a pattern change, or the like at a predetermined position as a principal component score.

The change reception unit 114 acquires the changed principal component score. The change reception unit 114 outputs the changed principal component score to the image generation unit 115 and the display control unit 116.

For example, the change reception unit 114 acquires, from the user terminal 200 via the network N, a value input by the user to the user terminal 200 as the changed principal component score. In addition to the change based on the input operation of the user, the change reception unit 114 may acquire a principal component score automatically changed based on, for example, a predetermined condition.

The image generation unit 115 generates the first reconstructed image and the second reconstructed image by reconstructing the original image based on the principal component vector and the principal component score. The image generation unit 115 generates a difference image of a difference between the first reconstructed image and the second reconstructed image. The image generation unit 115 outputs the first reconstructed image, the second reconstructed image, and the difference image to the display control unit 116.

The image generation unit 115 generates the first reconstructed image by reconstructing the original image based on the principal component vector and the principal component score acquired by the feature amount acquisition unit 113. The principal component score used to generate the first reconstructed image is the principal component score before the change.

The image generation unit 115 generates a second reconstructed image by reconstructing the original image based on the principal component vector acquired by the feature amount acquisition unit 113 and the principal component score acquired by the change reception unit 114. The principal component score used to generate the second reconstructed image is a more modified principal component score of the user, that is, a modified principal component score.

The image generation unit 115 calculates a difference between the first reconstructed image and the second reconstructed image, and generates a difference image based on the difference. The difference image is an image that visualizes where the change occurs in the original image due to the change in the principal component score. By using the first reconstructed image to generate the difference image, the image generation unit 115 can suppress the influence of the difference between the difference image and the original image or the masking image caused by the reconstruction error caused by the dimensional compression of the principal component analysis in the difference image. Therefore, through the difference image, the user can easily interpret the variation of the image due to the change of the principal component score.

The display control unit 116 acquires a feature amount from the feature amount acquisition unit 113, and acquires an image generated from the image generation unit 115. The display control unit 116 displays a feature amount and an image.

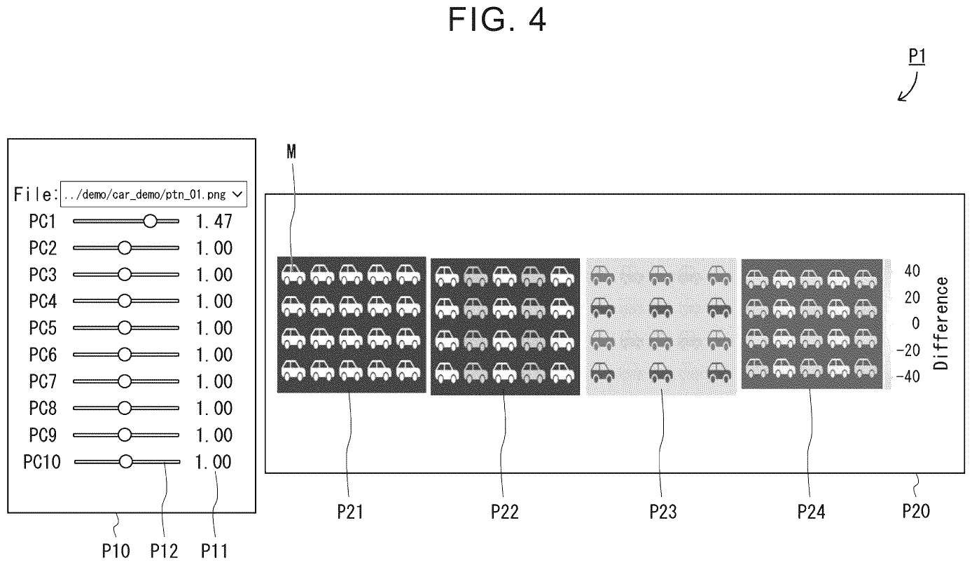

With reference to FIG. 4, an example of a configuration of a display screen displayed on the user terminal 200 by the display control unit 116 will be described. FIG. 4 is a schematic diagram illustrating an example of a configuration of a display screen displayed on a user terminal by the display control unit according to the first embodiment; As illustrated in FIG. 4, the display P1 according to the first embodiment includes a first display area P10 and a second display area P20.

The first display area P10 is an area for displaying a characteristic quantity. As illustrated in FIG. 4, the first display area P10 displays a plurality of display units P11 and a plurality of change units P12.

The display unit P11 displays the principal component scores acquired by the feature amount acquisition unit 113. When the principal component score is changed by the change unit P12 described later, the display unit P11 displays the changed principal component score.

The change unit P12 is a User Interface (UI) element that accepts a change in principal component scoring. More specifically, the change unit P12 is a UI element such as a text box, a spin box, or a slider. The user operates the change unit P12 to change the principal component scoring. The display control unit 116 outputs the changed principal component score to the change reception unit 114.

The second display area P20 displays the first reconstructed image P21, the second reconstructed image P22, and the difference image P23. Thus, the user can easily interpret the variation of the object M in the image due to the change of the principal component score. The second display area P20 may display the second reconstructed image P22 and the difference image P23 regenerated based on the changed principal component score each time the principal component score is changed. Thus, the user can confirm the change in the image due to the adjustment of the principal component score in real time. The second display area P20 may further display the superimposed images P24. The superimposed image P24 is an image obtained by superimposing the difference image P23 on the first reconstructed image P21.

When the display control unit 116 displays the display P1 including the first display area P10 and the second display area P20, the user can efficiently check the variation of the images while changing the principal component scores.

### Operation of Analysis System

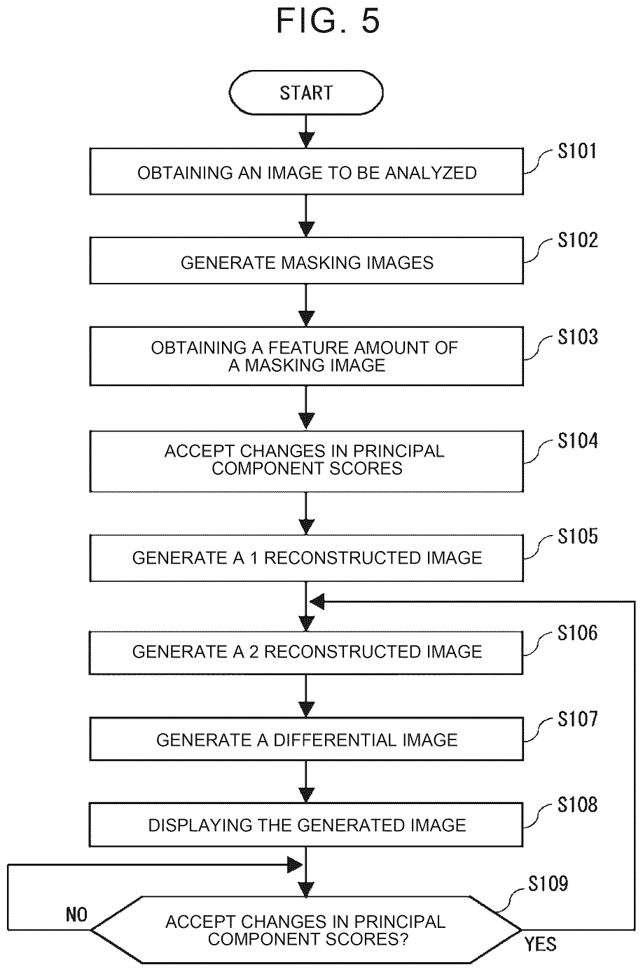

Next, an analysis method according to Embodiment 1 will be described. FIG. 5 is a flowchart illustrating an analysis method according to Embodiment 1.

In the processing procedure of FIG. 5, the processor 110 included in the server 100 functions as an image acquisition unit 111, an image processing unit 112, a feature amount acquisition unit 113, a change reception unit 114, an image generation unit 115, and a display control unit 116 by reading and executing a program stored in the storage device 130 into the memory 120.

In the analysis method according to the first embodiment, first, the processor 110 acquires an original image that is an image to be analyzed (S101). That is, in S101, the processor 110 functions as the image acquisition unit 111.

Next, the processor 110 generates a masking image in which an object other than the object is masked in the original image (S102). That is, in S102, the processor 110 functions as the image processing unit 112.

Next, the processor 110 performs two-dimensional principal component analyses on the masked images to obtain principal component scores and principal component vectors as feature quantities (S103). That is, in S103, the processor 110 functions as the feature amount acquisition unit 113.

The processor 110 then S104 the principal component scoring changes. That is, in S103, the processor 110 functions as the change reception unit 114.

Processor 110 then S105 the first reconstructed images based on the principal component vectors and the pre-modified principal component scores.

The processor 110 also S106 the second reconstructed images based on the principal component vectors and the modified principal component scores. Note that S105 may be executed simultaneously with S106 or after S106.

Then, the processor 110 calculates a difference between the first reconstructed image and the second reconstructed image, and generates a difference image based on the difference (S107).

That is, in S107 from S105, the processor 110 functions as the image generation unit 115.

The processor 110 then S108 the images generated in S107 from S105. That is, in S103, the processor 110 functions as the display control unit 116.

After displaying the images (S108), the processor 110 executes S106 again when the change of the principal component scoring is accepted (S109: YES).

As described above, the analysis system 1 according to the first embodiment acquires the feature amount of the masking image in which the object other than the object is masked in the original image. As a result, the analysis system 1 can accurately extract the feature amount of the object. Therefore, the analysis system 1 can easily interpret the feature amount by the user.

Although the present disclosure has been described with reference to the above embodiments, it is to be understood that the disclosure is not limited only to the configuration of the above embodiments, but also includes various modifications, modifications, and combinations that may be made by a person skilled in the art within the scope of the claimed disclosure of the claims of the present application.

In the first embodiment, the image generation unit 115 uses the first reconstructed image to generate a difference image. Note that the image generation unit 115 may use a masking image instead of the first reconstructed image. That is, the image generation unit 115 may calculate a difference between the masking image and the second reconstructed image, and generate a difference image based on the difference. In this case, the image generation unit 115 may not generate the first reconstructed image. That is, the processor 110 executes S106 without executing S105 illustrated in FIG. 5. Further, the display control unit 116 may display the masked image at the display position of the first reconstructed image P21 in the second display area P20 illustrated in FIG. 4.

In the first embodiment, the display control unit 116 displays the first reconstructed image P21, the second reconstructed image P22, the difference image P23, and the superimposed image P24 in the second display area P20. Note that the display control unit 116 may display only the first reconstructed image P21 and the second reconstructed image P22 in the second display area P20. Further, the display control unit 116 may display only the difference image P23 in the second display area P20. The display control unit 116 may further display the original image or the masking image in the second display area P20.

What is claimed is:

1. An analysis system comprising:
an image acquisition unit configured to acquire an image to be analyzed;
an image processing unit configured to generate a masking image in which an object in the image other than a target object is masked; and
a feature amount acquisition unit configured to acquire a feature amount in the masking image.

2. The analysis system according to claim 1, wherein the feature amount acquisition unit is configured to perform two-dimensional principal component analysis on the masking image to acquire a principal component score and a principal component vector as the feature amount.

3. The analysis system according to claim 2, further comprising:
a change reception unit configured to acquire the principal component score subjected to a change;
an image generation unit configured to generate a first reconstructed image based on the principal component vector and the principal component score before the change, and generate a second reconstructed image based on the principal component vector and the principal component score after the change; and
a display control unit configured to display the first reconstructed image and the second reconstructed image for a user.

4. The analysis system according to claim 3, wherein the image generation unit is configured to calculate a difference between the first reconstructed image and the second reconstructed image, and generate a difference image based on the difference.

5. An analysis method comprising:
acquiring an image to be analyzed;
generating a masking image in which an object in the image other than a target object is masked; and
acquiring a feature amount in the masking image.
